(19) United States
(12) Patent Application Publication
(10) Pub. No.: US 2022/0260256 A1
(43) Pub. Date: Aug. 18, 2022

(54) U-SHAPED AUGER TUBE ASSEMBLY

(71) Applicant: W.C. BRADLEY CO., Columbus, GA (US)

(72) Inventors: ANTHONY HAMILTON, Hamilton, GA (US); RAMIN KHOSRAVI RAHMANI, Columbus, GA (US); BRUCE ROBERTS, Phenix City, AL (US); DAN CORSO, Columbus, GA (US); SLEIMAN ABDALLAH, Columbus, GA (US)

(21) Appl. No.: 17/670,866

(22) Filed: Feb. 14, 2022

Related U.S. Application Data
(60) Provisional application No. 63/149,066, filed on Feb. 12, 2021.

(51) Int. Cl. F24B 13/04; A47J 37/07; F24B 1/02

(52) U.S. Cl. CPC F24B 13/04; F24B 1/024; A47J 37/0786

(57) ABSTRACT

An electrically driven auger selectively feeds fuel pellets from a pellet hopper to a fire pot inside a cooking grill. An auger tube has a lower radius cooperatively shaped with a circumference of the auger with a pair of spaced apart sidewalls extending upwardly from the radius to define an opening above the auger that is at least as wide as a diameter of the auger.

### CROSS-REFERENCE TO RELATED CASES

This application claims the benefit of U.S. provisional patent application Ser. No. 63/149,066, filed on Feb. 12, 2021, and incorporates such provisional application by reference into this disclosure as if fully set out at this point.

### FIELD OF THE INVENTION

This disclosure relates to pellet fueled grills in general and, more particularly, to an auger tube assembly for a pellet fueled grill.

### BACKGROUND OF THE INVENTION

Pellet fueled or pellet fired outdoor cooking appliances rely on pelletized fuel, often comprising wood or wood by-product pellets to produce heat and/or smoke for cooking. These may utilize a screw auger to deliver the pellets to a firepot from a hopper accessible outside the cooking chamber. A fan may deliver air to the firepot to improve combustion inside the cooking chamber and/or combustion chamber.

It has been found in widespread field usage that problems can develop that lead to the auger jamming and preventing feed of pellets to the firepot, and therefore interruption of the cooking function. Most typically these auger jams are caused by some level of moisture accumulation during a period of time when the auger is not operating but fuel pellets remain in the auger. The moisture can break down the cohesiveness of the pellets which is based on natural material found in the wood that is easily dissolved by water molecules. In that situation a resulting paste-like material developed by the breakdown of the wood pellets can accumulate around the auger and prevent rotation of the auger.

What is needed is a system and method for addressing the above and related problems.

### SUMMARY OF THE INVENTION

The invention of the present disclosure, in one aspect thereof, comprises a system having an electrically driven auger that selectively feeds fuel pellets from a pellet hopper to a fire pot inside a cooking grill, and an auger tube having a lower radius cooperatively shaped with a circumference of the auger with a pair of spaced apart sidewalls extending upwardly from the radius to define an opening above the auger that is at least as wide as a diameter of the auger.

In some embodiments, the opening above the auger is greater than a diameter of the auger. The lower radius of the auger tube may define an arc of a circle. Each of the pair of paced apart side walls may be planar. In another embodiment, each of the pair of paced apart sidewalls is curved in profile. The auger tube may be u-shaped in profile. The system may include a removable cover fitting the opening above the auger.

The invention of the present disclosure, in another aspect thereof, comprises a grill having a cooking chamber containing a fire pot, an auger selectively transporting fuel pellets from outside the cooking chamber to the fire pot, and an auger tube aligned with and adjacent to the auger and having a lower radius cooperatively shaped with a circumference of the auger with spaced apart sidewalls extending upwardly from the radius to define an opening above the auger that is equal to or wider than the diameter of the auger.

In some embodiments, the auger tube is u-shaped in profile. The spaced apart side walls may be planar. The auger tube may define an upper portion of an air plenum selectively delivering forced combustion air to the fire pot promoting combustion. The grill may have a top covering the opening above the auger. At least a portion of the top covering may beq removable.

The invention of the present disclosure, in another aspect thereof, comprise a system having a fuel pellet hopper outside a cooking chamber, a fire pot inside the cooking chamber, an auger tube traversing from the fuel pellet hopper, through the cooking chamber and to the fire pot, and an auger within the auger tube moving fuel pellets from the hopper to the fire pot. The top of the auger tube comprises a pair of spaced apart side walls that are a greater distance from the auger than a bottom of the auger tube.

The system may include an air plenum delivering combustion air from outside the cooking chamber to the fire pot, wherein the auger tube traverses a volume of the air plenum and does not extend above a top of the air plenum. The auger tube may have a top opening defined between the pair of spaced apart side walls that is accessible from the top of the air plenum. The auger tube may have a top cover selectively covering the top opening that is removable from outside the air planum.

In some embodiments, the bottom of the auger tube defines an arc of a circle. The arc of the circle of the bottom of the auger tube may correspond to a circumference of the auger in profile. In some cases, the spaced apart side walls are planar and extend upwardly from the bottom of the auger tube.

### BRIEF DESCRIPTION OF THE DRAWINGS

FIG. 1 is a side cutaway view of a pellet grill.

FIG. 2 is a perspective view of an auger tube assembly according to aspects of the present disclosure.

FIG. 3 is a perspective end cutaway view of the auger tube assembly of FIG. 2.

FIG. 4 is an end cutaway view of the auger tube assembly of FIG. 2.

### DETAILED DESCRIPTION OF THE PREFERRED EMBODIMENTS

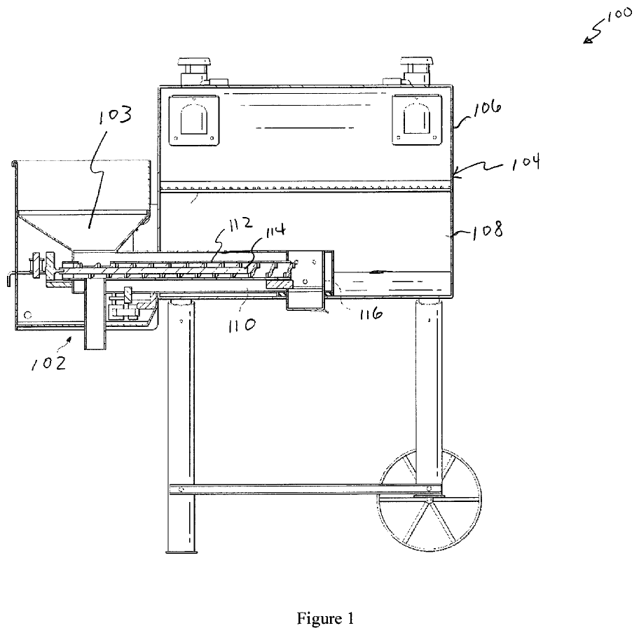

FIG. 1 is a side cutaway view of a pellet grill 100. Such a grill 100 may generally comprise a pellet feed mechanism 102 having an electrically driven auger 114 rotating within an auger tube 112 selectively or periodically feeding fuel pellets into a firepot 116 located in a fire chamber 108 of a grill body 104. Fuel pellets are provided to the auger 114 via a hopper 103 of the pellet feed mechanism 102. Various electronic controls and/or switches may be provided as are known in the art.

The fire chamber 108 may provide heat and/or smoke from the firepot 116 to a superiorly located cooking chamber 106, which may form an upper portion of the grill body 104. Various food support apparatus such as cooking grates, rib racks, and other implements as known in the art may be deployed on or in the grill body 104 to aid in cooking. The grill 100 may operate primarily by smoking, primarily by heating, and/or any other cooking method known in the art. The grill body 104 may also take on a variety of shapes and configurations and be provided with various ventilation and air flow mechanisms. A forced air plenum 110 may surround the auger tube 112 and may provide combustion air to the firepot 116.

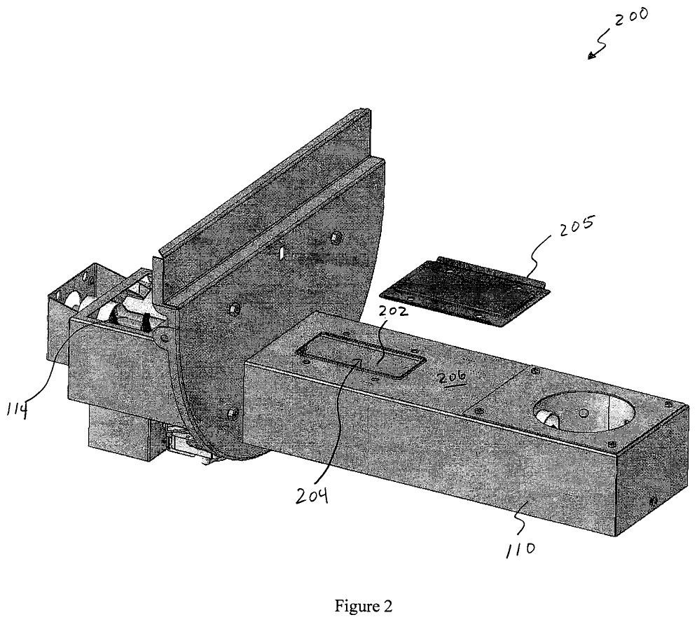

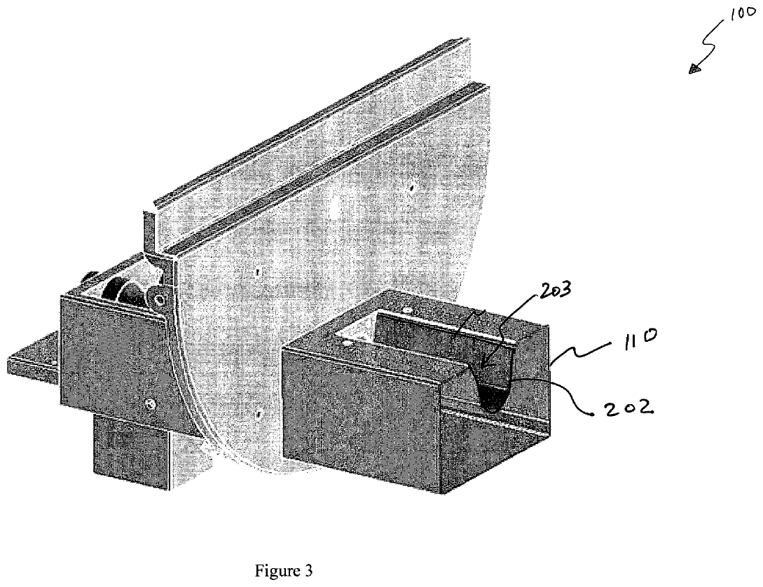

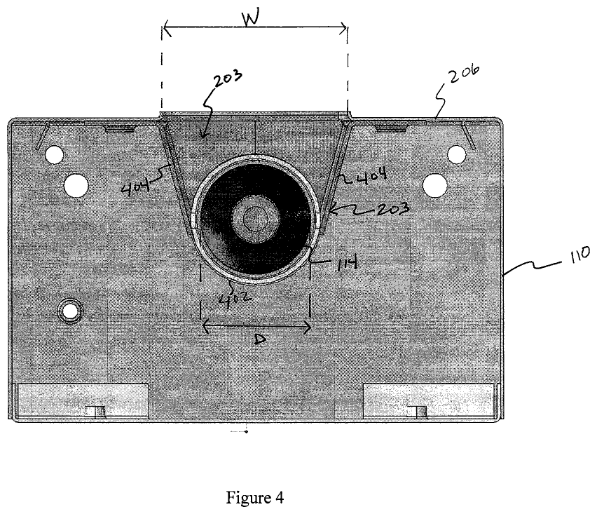

FIG. 2 is a perspective view of an auger tube assembly 200 according to aspects of the present disclosure. FIG. 3 is a perspective end cutaway view of the auger tube assembly 200 of FIG. 2, while FIG. 4 is an end cutaway view of the same. The auger tube assembly 200 may contain the auger 114 but may provide a u-shaped tube 202, possibly contained in the plenum 110. Instead of having a round tube (e.g., 112) around the horizontal auger 114 from the hopper 103 to the firepot 116, the u-shaped tube 202 may define a u-shaped channel 203 with a bottom radius 402 corresponding closely to the radius of the auger 114 and upwardly sloping side walls 404 creating an open top 204 larger in width ‘W’ than the diameter ‘D’ of the auger 114. The side walls 404 may be straight (in profile) or planar, or may be curved. The side walls 404 may be formed of joined segments (straight or curved).

The open top 204 may be above or superior to auger 114 by some predetermined distance. This opening 204 may be covered with a flat plate or top cover 205, some or all of which may be removable for access to the auger 114 from above.

Described another way, the auger tube 202 is shaped like a trough rather than a cylinder. The trough may be placed into is placed into the air plenum 110, or be said to occupy part of the interior space of the air plenum 110. In some embodiments the open top 204 is at or near an upper boundary or edge of the plenum 110 such that the plate or top cover 205 is on the same level as an upper or top level 206 of the plenum 110. In such a configuration, the auger tube may define part of the upper boundary of the volume of the air plenum.

View in transverse section (e.g., as in FIG. 4) a bottom or radius 402 of the trough (tube 202) can see seen to form an arc of a circle. This arc may be the same or a similar arc, geometrically, as formed by the auger 114 when viewed in the same transverse section. In some cases, the arc or radius 402 may be slightly wider or larger than the corresponding arc of the auger 114 to allow for the radius 402 to have a constant distance from the auger 114 near the bottom thereof. The side walls 404 may appear straight in transverse section (e.g., when they are planar in three dimensions) and widen from one another as the progress away from the auger 114. As stated above, the final width ‘W’ of the walls 404 may be greater than a diameter of the auger 114.

The radius or bottom 402 of the auger 114 may be near to contact with the auger 114 but may be spaced apart by at least a small margin such that the auger 114 does not drag on the tube 202 when in operation. The auger 114 may come near enough to the tube 202 that fuel pellets cannot pass between the auger 114 and tube 202 such that all pellets in the tube 202 are moved when the auger 114 rotates. The auger 114 may be placed closer yet to the tube 202 such that even most broken pellets are moved when the auger 114 rotates. As discussed below, however, one of the benefits of the present system is that the auger 114 is not in such close proximity to the tube 202 around the entire circumference of the auger 114.

When or if moisture infiltrates any of the cooking system, via condensation, leakage, or otherwise, and the fuel pellets begin to form a clogging paste or other blockage, several advantages may be enjoyed with the systems of the present disclosure. Firstly, since the u-shaped tube 202 does not fit as closely with the entire circumference of the auger 114 as previous systems (e.g., the auger 114 is only closed fitting to the u-shaped tube 202 near the radius 402), any mechanical impedance to auger rotation created by this paste like material or other blockages may as little as half or less as much as in prior systems. Additionally, if, despite this, the auger 114 is prevented from rotating, the removeable cover 205 placed over all or part of the upper part (open top 204) of the u-shaped tube 202 can be removed for easy removal of blockages.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26 -100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

The term “selective” or “selectively,” unless otherwise indicated, is taken to mean that the operation or function is capable of being performed by the structure or device in reference, but the operation or function may not occur continuously or without interruption. Furthermore, a selective or selectively performed operation may be one that the user or operator of a device or method may choose whether or when to perform, but the function or operation is nevertheless fully operative on or within the relevant device, machine, or method and the same includes the necessary structure or components to perform such operation.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system comprising:
an electrically driven auger that selectively feeds fuel pellets from a pellet hopper to a fire pot inside a cooking grill; and
an auger tube having a lower radius cooperatively shaped with a circumference of the auger with a pair of spaced apart sidewalls extending upwardly from the radius to define an opening above the auger that is at least as wide as a diameter of the auger.

2. The system of claim 1, wherein the opening above the auger is greater than a diameter of the auger.

3. The system of claim 1, wherein the lower radius of the auger tube defines an arc of a circle.

4. The system of claim 3, wherein each of the pair of paced apart side walls is planar.

5. The system of claim 4, further comprising a removable cover fitting the opening above the auger.

6. The system of claim 3, wherein each of the pair of paced apart sidewalls is curved in profile.

7. The system of claim 3, wherein the auger tube is u-shaped in profile.

8. A grill comprising:
a cooking chamber containing a fire pot;
an auger selectively transporting fuel pellets from outside the cooking chamber to the fire pot; and
an auger tube aligned with and adjacent to the auger and having a lower radius cooperatively shaped with a circumference of the auger with spaced apart sidewalls extending upwardly from the radius to define an opening above the auger that is equal to or wider than the diameter of the auger.

9. The grill of claim 8, wherein the auger tube is u-shaped in profile.

10. The grill of claim 8, wherein the spaced apart side walls are planar.

11. The grill of claim 8, wherein the auger tube defines an upper portion of an air plenum selectively delivering forced combustion air to the fire pot promoting combustion.

12. The grill of claim 11, further comprising a top covering the opening above the auger.

13. The grill of claim 12, wherein at least a portion of the top covering is removable.

14. A system comprising:
a fuel pellet hopper outside a cooking chamber;
a fire pot inside the cooking chamber;
an auger tube traversing from the fuel pellet hopper, through the cooking chamber and to the fire pot; and
an auger within the auger tube moving fuel pellets from the hopper to the fire pot;
wherein the top of the auger tube comprises a pair of spaced apart side walls that are a greater distance from the auger than a bottom of the auger tube.

15. The system of claim 14, further comprising an air plenum delivering combustion air from outside the cooking chamber to the fire pot, wherein the auger tube traverses a volume of the air plenum and does not extend above a top of the air plenum.

16. The system of claim 15, wherein the auger tube has a top opening defined between the pair of spaced apart side walls that is accessible from the top of the air plenum.

17. The system of claim 16, wherein the auger tube has a top cover selectively covering the top opening that is removable from outside the air planum.

18. The system of claim 17, wherein the bottom of the auger tube defines an arc of a circle.

19. The system of claim 17, wherein the arc of the circle of the bottom of the auger tube corresponds to a circumference of the auger in profile.

20. The system of claim 19, wherein the spaced apart side walls are planar and extend upwardly from the bottom of the auger tube.
